(19) United States
(12) Patent Application Publication
(10) Pub. No.: US 2014/0027290 A1
(43) Pub. Date: Jan. 30, 2014

(54) ELECTRO-CHEMICAL PROCESS FOR DECORATING ALUMINUM SURFACES

(71) Applicants: Roberto Giovanardi, Soliera MO (IT); Gianpaolo Orlando, Modena MO (IT)

(72) Inventors: Roberto Giovanardi, Soliera MO (IT); Gianpaolo Orlando, Modena MO (IT)

(73) Assignee: METALY S.R.L., Formigine (IT)

(21) Appl. No.: 13/984,803

(22) PCT Filed: Feb. 11, 2012
(86) PCT No.: PCT/IB12/00240

§ 371 Date: Oct. 16, 2013

(30) Foreign Application Priority Data
Feb. 11, 2011 (IT) MO2011A000028

(51) Int. Cl. B41M 5/20

(52) U.S. Cl. CPC B41M 5/20
USPC 205/52

(57) ABSTRACT

An electrochemical process for decorating a surface, includes marking by a screen or mask which can be subsequently removed to create a decoration including a design, mark or writing, by use of an electrochemical etching solution maintained between a surface to be decorated and an electrode exerting pressure, the surface and the electrode being connected to a generator of electrical current, a pad impregnated with the etching solution being placed between the surface and the electrode, to form a layer of oxide with a thickness of a few thousandths of a micrometer on the surface, and anodizing the decorated surface to form an other layer of oxide, the other layer of oxide being 10 micrometers in depth. The other layer of forms on the surface on which the decoration is applied, maintaining its morphology, and the layer of oxide limits a formation of the other layer of oxide, while at the same time acting upon and emphasizing the morphology of the decorated surface.

### FIELD OF APPLICATION

The invention under discussion concerns an electrochemical procedure for decorating a surface in aluminium and its alloys, that is a new method of applying designs, decorations or writing so that they remain permanently on the aluminium surface without losing their shape even when acted upon by external agents, such as atmospheric pollution, humidity, fatty acids from the skin, heat, light, and in particular ultraviolet radiation, as well as aggressive action from chemical cleaners normally used in cleaning the surface of objects.

### Known Technique

The technique comprises the well-known procedure of anodizing an aluminium surface, which, when performed on objects, whether three dimensional or flat, creates a layer of aluminium oxide which protects the metal and renders impermeable contact with the atmosphere, including products used for cleaning the surface and objects, and the metal itself. This procedure does not, however, make decoration possible, since it is done by submerging the object, plate or aluminium body in a bath which, by means of the electrochemical action envisaged, develops a superficial layer of aluminium oxide which coats the entire surface of the object, sheet or treated body. The layer of metallic oxide thus obtained is firmly attached to the aluminium and protects it from further contact with the outside environment.

The technique of electro-chemical marking a metal surface is also well known, an action which is possible when the metal surface conducts an electrical current, albeit very weak, to excite etching to the metal surface of the chemical solutions used; chemical solutions that can be used on aluminium are commercially available, but the results of marking are unsatisfactory. This technique is, however, not applicable to anodized aluminium since the anodizing layer prevents the electrochemical action of the marking of the anodized aluminium.

In fact, electro-chemical marking on non-anodized aluminium by the known technique produces unsatisfactory results given the weak colouring action (or blackening of the markings) obtained as a consequence of the subsequent which dissolves the surface-layer marking and transforms it into aluminium oxide, thus englobing it.

Techniques for decorating anodized aluminium have used a wide variety of methods of treatment or surface printing.

Various procedures are also known whereby the anodized aluminium is coloured by acting immediately after anodizing and before the pores of the protective aluminium oxide layer are completely closed. Silk-screen printing and wet stamping processes are also well known whereby a very thin layer of ink is transferred and deposited on the surface of the protective oxide stratum without penetrating it.

A very commonly used method for decorating anodized aluminium is etching, by mechanical means or with a tool, whereby the metal surface of the aluminium is incised to a depth of between a few tenths of a millimetre to a few millimetres, and the design, marking or decoration impressed on the surface is stabilized, later to be coloured with conventional paints.

From the previous document US 2004/0118813 A1 a method is known for decorating a metal surface, specifically aluminium and of limited dimensions, such as for the casings of portable electrical equipment, by corroding the metal in points determined in advance in such a way as to create blind holes in the areas exposed to the chemical corrosion of the metal; the points of etching being obtained by using a mask produced by a protective film, which is spread on the surface that is to be treated and etched by the action of etching of the said film, such as to make the underlying metal surface sensitive to the subsequent corrosive action; after the treatment the film is removed. The document describes the use of protective films applied by painting or printing in materials which are resistant to the action of chemical corrosion. The distribution of the holes on the protective film is achieved by laser or other mechanical systems which etch the protective film. Corrosion takes place when the aluminium surface is submerged in a bath with a solution whose alkaline concentration is between 10 and 100 g/l at a temperature of 90° centigrade. As a variation, the document cites a bath of acid solution or conventional electrochemical corrosion. Finally, the document indicates a procedure for protecting the treated surface with small covers by means of a protective layer of acrylic or polyurethane paint, which can also be coloured. It further indicates a possible protective coating of the aluminium surface using an anodizing procedure with a layer one tenth of a micrometer in depth such as to protect at least the treated surface external to the blind holes. This techniques foresees the application of colours to the said surface while the pore of the aluminium oxide grain is still open, before being closed in boiling water. This decorative method may also comprise, apart from forming blind holes by mechanical means, the creation of points for insertions in various materials and with colours different from that of the surface, in order to create a more decorative effect.

As mentioned above, the electro-chemical marking action is not applied to anodized aluminium since the aluminium must conduct electricity. In the treatment used in the document cited above, it is electrochemical corrosion that proves most useful in creating the blind holes, while not allowing the formation of complex decorations with variable surface texture, albeit of minimum depth, of the order of a few micrometers or even of thousandths of a micrometer, and covering the entire surface of the aluminium being treated. This is because the formation of oxide on the decoration thus extended, as also with electrolytic corrosion in the single blind hole, impedes the subsequent formation of the coating. For this reason, treatments for decoration preliminary to anodizing are unknown, since the said treatments or operations to obtain a decorative effect are not compatible with the subsequent coating, given that the creation of a layer of oxide due to electrochemical corrosion prevents the later creation of a layer of anodized oxide, and thus coating in the blind holes is not ensured, but only the metal surface around those holes is anodized.

Furthermore, the preceding document US 2004/0056000 A1 also describes a method which makes use of electrochemical corrosion whereby an object is submerged in an electrolytic solution after protection of the three-dimensional surface at selected points, such as to obtain a marked reduction in the relief of the metal surface, on which subsequent anodizing ensures protection from oxidation according to shape, that is, a three-dimensional surface is obtained of the desired shape and anodized.

Furthermore, the known treatments for decorating an aluminium surface, if carried out prior to anodizing, as in the case of silk-screen printing and wet stamping methods, produce a layer of ink which is removed with cleaning prior to the anodizing of the aluminium surface, and mechanical, chemical and electrochemical etching produces marked variations in the metal surface, which generally proves unsuitable prior to anodizing.

Furthermore, current technical descriptions include document GB 1036520 which outlines another method for decorating aluminium involving the mechanical superimposition of two or more layers of thin aluminium which have already been anodized and/or have different thicknesses, colour or shading. The outer layer is protected by a mask to create a design or graphic shape and then chemically etched so as to expose the underlying layer of aluminium, whose colour is different, and to render the design visible. In this case, in the design or graphic shape, the surface is not protected from oxidation, not having undergone treatment.

Furthermore, current technical descriptions include documents which outline a method of decorating an aluminium surface directly using an anodizing treatment of the same. These methods, for example DE 3843435 or also DE 1236983, indicate prior protection of the aluminium surface to be treated with the design or writing to be obtained, then the anodizing treatment of the surface, protected by masking, is performed; where the protective material has impeded oxidation, that is the anodizing of the surface, a design or mark or writing is obtained on said surface. In this case, however, on the design, the writing or mark, the surface is not protected from oxidation, not having undergone the anodizing treatment.

Finally, the use of aluminium in the anodized form is certainly more advantageous, useful and suitable than the metallic surface that has not been treated, since, as is well known, anodizing confers rigidity and greater surface hardness on the aluminium object, making it more resistant in time and to mechanical stresses such as abrasions to which it will be subjected, quite apart from the surface etching issues mentioned above.

Current techniques in electrochemical procedures for decorating aluminium can be further refined so as to circumvent the above-mentioned obstacles to decorating anodized aluminium, making the application of a selected decoration, design, mark or writing to the surface of anodized aluminium fast, practical and easy, and extending the anodizing protection to the entire metallic surface, including the decoration, design, mark or writing.

Thus, the technical problem addressed by this invention is how to perform an electrochemical procedure to decorate aluminium, whereby it becomes possible to anodize the surface in question, including a decoration of any size with regard to the surface under treatment.

Our purpose, inherent in the foregoing technical problem, is to create a method which makes it possible to apply the decoration to the aluminium, without affecting the subsequent layer of aluminium oxide and breeding it to the decoration of the treated metallic surface.

Finally, a further aspect of the technical problem outlined above concerns inventing a procedure which enables us to apply the required decoration, design, mark or writing as widely as possible, and which is compatible with anodizing techniques currently used on bodies, objects, sheets or surfaces in aluminium without limitations on size; or to apply it to subsequent work on the treated surface, also by mechanical means, without damaging the decoration, mark or design of the said surface.

### SUMMARY OF THE INVENTION

This problem is resolved by the invention here outlined, which proposes a procedure for decorating an aluminium surface comprising the application of the decoration by means of a screen or mask, similar to that used in silk-screen printing, which is formed of ink or film, and which temporarily masks the surface of the required decoration, mark or design, and which features the following steps:

marking by means of a screen or mask which can be subsequently removed to create a specific design, mark or writing by means of an electrochemical etching solution, maintained between the surface to be decorated and the electrode exerting pressure, the metallic surface and the electrode being connected to a generator of electrical current, between which a pad is placed impregnated with the etching solution; thus creating a layer of aluminium oxide with a thickness of a few thousandths of a micrometer on the decoration obtained;

anodizing of the decorated object as above, using known anodizing methods selected for the specific aluminium object, sheet or surface to be treated; the layer of oxide due to anodizing presents a typical thickness superior to 10 micrometers and, with the layer of oxide generated by the preliminary decoration still present in nanometric amounts, that is thousandths of a micrometer, the oxide layer also forms on the surface affected by the decoration, maintaining its form, which is visible to the naked eye.

In a further application, the procedure comprises the addition of colour to the anodized layer and the subsequent closing of the pores of said layer. Further still, in a specific procedure, after first decorating the aluminium object, sheet or surface, the said surface undergoes further electrochemical marking before being anodized.

In addition, in an alternative form of construction, the electrode which exerts pressure during decoration features a spatula in a material which conducts electricity.

Furthermore, in a specific design variation, the electrode which exerts pressure during decoration comprises a roller in a material which conducts electricity.

Finally, in a further application, subsequent to the phase of electrochemical marking, the aluminium surface to which the decoration is applied undergoes a cleaning phase in which residues from the etching solution and/or the mask are removed.

The features and benefits of the invention here outlined for creating an electrochemical procedure for decorating an aluminium surface, will emerge from the description which follows, wherein examples of treatment for decoration are cited as indications, not limitations, and refer to the three accompanying drawings.

### BRIEF DESCRIPTION OF THE DRAWINGS

FIG. 1 represents a limited and enlarged schematic section of a portion of anodized aluminium to which the procedure outlined in the description of this invention has been applied;

FIG. 2 represents a limited schematic section of a portion of anodized aluminium, as in FIG. 1, without, however, the decoration;

FIG. 3 represents a schematized view of a generic example of a decorative design applied to a surface following the procedures proposed by this invention;

FIG. 4 represents a section seen through the electronic microscope, which, as explained below, is created by placing two surfaces of anodized aluminium together in the sample, in this case: in the lower part of the Figure a surface of anodized aluminium is present without a decoration; in the upper part, rotated and affixed to the lower part on the outer anodized surface, a surface of anodized aluminium is present to which the decorative procedure as per the invention here described has been applied.

### DETAILED DESCRIPTION OF A SELECTED FORM TO BE CREATED

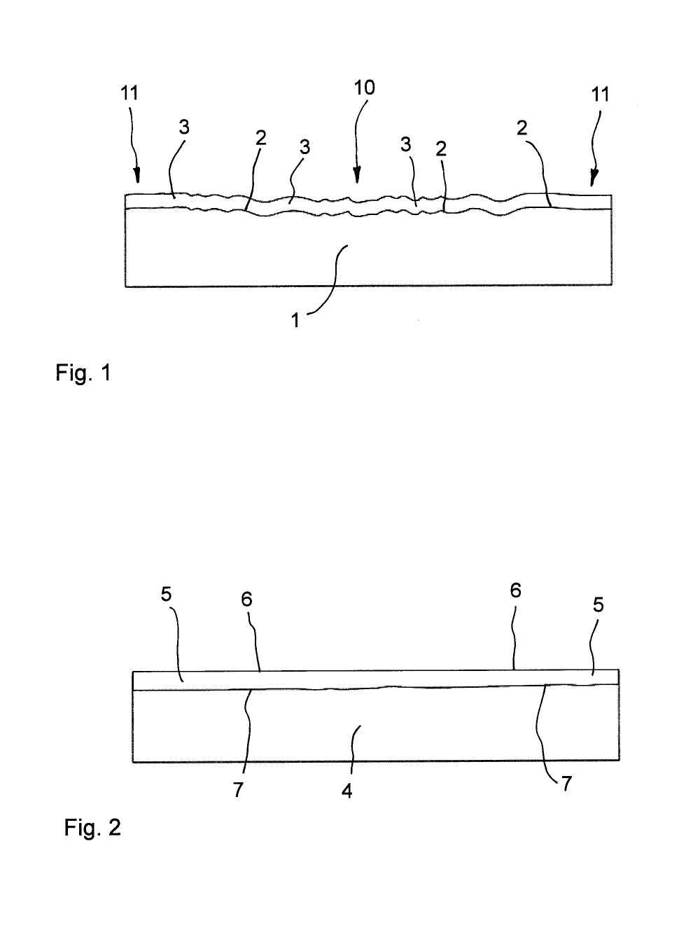

In FIGS. 1 and 2, sections are visible which are limited to the superficial layer of an anodized aluminium surface. In FIG. 1, the metal 1 can be seen revealing the wrinkled effect 2 left by the invention's decorating procedure, and on which, with anodizing, a layer of aluminium oxide 3 has been formed, which follows the line of wrinkling 2 mentioned above. Similarly, FIG. 2 shows the metal 4 on which, as a result of anodizing treatment, a layer of aluminium oxide 5 has been created of uniform thickness with a tendency to generate a surface 6 in line with the surface of the metal as it was before anodizing 7. A comparison between the two figures, which are still schematic, reveals the almost uniform thickness of the oxide layer 3, which replicates the underlying wrinkling 2 and is generated by the electro-chemical decorative treatment of the invention here outlined.

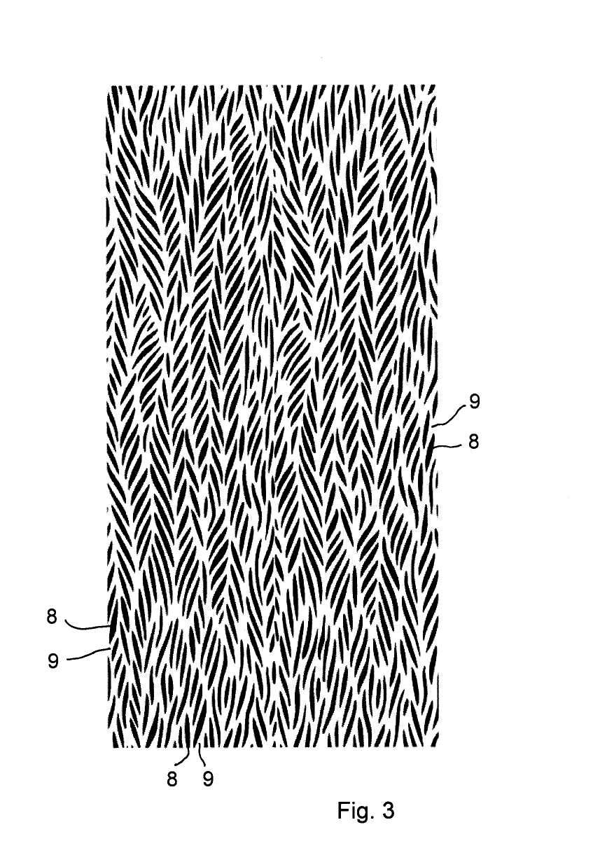

In FIG. 3, a generic design form is shown which can be created on the aluminium surface following the procedure proposed by this invention, in which the shapes in black 8 are the designs that are to be produced and where the wrinkling 2 will be generated. Between these shapes 8 clear areas 9 are present, that is where the screen, or other form of mask envisaged for this design, prevents the action of electro-chemical etching to the aluminium surface. These wrinkled and non-wrinkled areas are indicated in FIG. 1 by 10, the wrinkled area, where the decoration is created, and by 11, the area where etching does not occur because it is protected by the removable screen or mask, where the surface of the metal is not etched during decoration.

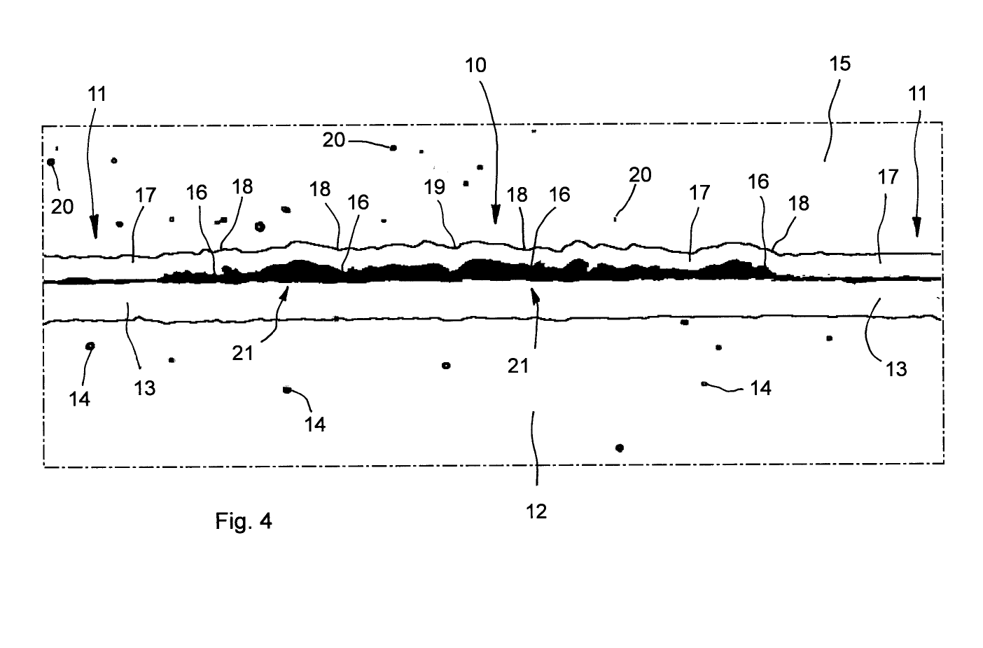

FIG. 4 presents the two real surfaces, like those in FIGS. 1 and 2, combined and connected in a single sample which, in the interests of precision and reliability of outcome, must be created when the effect of the decoration treatment proposed by this invention is studied under an electronic microscope.

The section 12 of the undecorated anodized aluminium surface presents the oxide layer 13 as in FIG. 2; spots 14, as inclusions, are present in the thickness of aluminium surface. Similarly, the section 15 of the anodized and decorated aluminium surface with wrinkling 16 external to the anodized part, presents a layer of oxide 17 which has formed in a more irregular way than the wrinkling 18 present before. In fact, the growth of the oxide layer 17 occurs as a result of the presence of the first nanometric layer of aluminium oxide, generated by electro-chemical marking in such a way as to reduce the electrical conductivity of the decorated surface and the surface variations here present. The presence of a nanometric oxide layer can be detected with a decoration created by electro-chemical marking that covers the surface of the decoration obtained with a white colour, still weak, but visible to the naked eye, compared with the adjacent metal surface typical of non-treated aluminium.

Where surface variations 19 are present, the layer of oxide is thicker, that is the visible wrinkling increases after the anodizing treatment, since the masking effect of the nanometric layer of aluminium oxide limits the formation of the oxide on the anodized layer. At the same time, the growth moves to the decorated surface, accentuating it with a greater volume of aluminium oxide compared with the volume occupied by the same aluminium atoms before. Thus, the final wrinkling of the decorated and anodized surface is greater than before, that is the decorated part, as a result of the increased volume of anodic oxide which has been oriented. In fact, the decoration effect, following anodizing treatment, is exalted and the final wrinkling accentuates the marking of the decoration, design or sign thus obtained. In addition, the presence of the nanometric layer of the first oxide, following electro-chemical marking, is detectable by the limited increase in the anodizing layer between the wrinkled area 11, which is on average less thick than the layer of anodic oxide, and the area not etched 11 which presents greater and more regular thickness of the anodic oxide layer obtained, as is seen in FIG. 4.

Spots 20 are also present in this section 15 as inclusions in the thickness of the aluminium. The black band between the two layers of oxide 13 and 17 is what is seen under the electronic microscope, and is due to the filling resin 21 used for preparing the sample under analysis. In fact, the thinness of the layers on the surfaces to be analysed, being very thin of the order of a few micrometers, means they need to be carefully prepared, first protecting the surfaces with a special resin, then placing one sample against another, bringing together the two surfaces so as to analyse them at the same time; that is, cutting the sample that has been created and lapping the surface that has been created. Subsequently, when the section is analysed by electron-microscope scan (SEM), and using a retro-diffused electron detector with magnification of at least 300×, an image is obtained like that in FIG. 4.

The method of decoration described above is applicable to all surfaces in aluminium with aluminium alloys that can undergo anodizing treatment; there are no limits on size apart from practical constraints to do with creating a screen and performing electro-chemical marking operations, which can also be done on large-format sheet-metal surfaces. In addition, the decoration can be applied at different moments, given that anodizing has no time limits, which is to say that a sheet or object undergoing electro-chemical marking can be stored in a warehouse and decorated several times with different designs, marks and writing, before being anodized.

The advantages of the electrochemical procedure for decorating a surface in aluminium or its alloys proposed by the invention outlined here can be summed up as follows.

The decoration, design or mark created is much more stable than any that have so far been achieved using this technique; it is not subject to wear from contact with oily agents or from solvents used in cleaning, it preserves its original definition and is resistant to the effects of heat, light and, above all, ultraviolet rays.

In addition, the procedures for decorating aluminium described above do not limit the size of the surface to be treated, that is, this procedure is designed for the industrial production of large quantities of objects and/or sheets in aluminium with decorated surfaces. In other words, the aluminium sheets can be mechanically worked following the procedure described above.

Finally, as mentioned above, the preparatory treatment for decoration can be carried out several times before anodizing, giving the treated surface an appearance which stems from the sum of the design, decorations, shapes or marks, and which is the result of their superimposition.

Clearly, a procedure such as that described above for decorating an aluminium surface might be modified in various ways by a copper technician to meet specific, contingent requirements, all of which would fall within the ambit and protection of the invention as defined by the following claims.

1. An electrochemical process for decorating a surface, comprising:
marking by a screen or mask which can be subsequently removed to create a decoration comprising a design, mark or writing, by use of an electrochemical etching solution maintained between a surface to be decorated and an electrode exerting pressure, the surface and the electrode being connected to a generator of electrical current, a pad impregnated with the etching solution being placed between the surface and the electrode, to form a layer of oxide with a thickness of a few thousandths of a micrometer on the surface; and
anodizing the decorated surface to form an other layer of oxide, the other layer of oxide being 10 micrometers in depth,
wherein the other layer of forms on the surface on which the decoration is applied, maintaining its morphology, and
wherein the layer of oxide limits a formation of the other layer of oxide, while at the same time acting upon and emphasizing the morphology of the decorated surface.

2. The electrochemical process for decorating a surface as per claim 1, further comprising:
applying color to the anodized layer whereby the pores of said layer are closed.

3. The electrochemical process for decorating a surface as per claim 1, wherein, following a preliminary decoration of the surface, the decoration is submitted to a least one more electrochemical marking prior to the anodizing treatment.

4. The electrochemical process for decorating a surface as per claim 1, wherein the electrode used to apply pressure during the decoration procedure is equipped with a spatula made of a material which conducts electricity.

5. The electrochemical process for decorating a surface as per claim 1, wherein the electrode used to apply pressure during the decoration procedure is equipped with a roller made of a material which conducts electricity.

6. The electrochemical process for decorating a surface as per claim 1, wherein, subsequent to the marking, a phase takes place in which the surface is cleaned and washed so as to remove residual etching and/or masking solution.

7. The electrochemical process of claim 1, wherein the decoration comprises one of a mark and a design.

8. The electrochemical process of claim 1, wherein the surface comprises a metallic surface.

9. The electrochemical process of claim 1, wherein the metallic surface comprises aluminum and the oxide comprises aluminum oxide.
